(19) United States
(12) Patent Application Publication
(10) Pub. No.: US 2023/0419546 A1
(43) Pub. Date: Dec. 28, 2023

(54) ONLINE CAMERA CALIBRATION FOR A MOBILE ROBOT

(71) Applicant: Boston Dynamics, Inc., Waltham, MA (US)

(72) Inventors: Christopher Christopher, Bedford, MA (US); Dion Gonano, Somerville, MA (US)

(73) Assignee: Boston Dynamics, Inc., Waltham, MA (US)

(21) Appl. No.: 18/335,661

(22) Filed: Jun. 15, 2023

Related U.S. Application Data
(60) Provisional application No. 63/354,762, filed on Jun. 23, 2022.

(51) Int. Cl. G06T 7/80; G06V 10/20; G06T 7/70

(52) U.S. Cl. CPC G06T 7/85; G06V 10/255; G06T 7/70; G06T 2207/30244

(57) ABSTRACT

Methods and apparatus for online camera calibration are provided. The method comprises receiving a first image captured by a first camera of a robot, wherein the first image includes an object having at least one known dimension, receiving a second image captured by a second camera of the robot, wherein the second image includes the object, wherein a field of view of the first camera and a field of view of the second camera at least partially overlap, projecting a plurality of points on the object in the first image to pixel locations in the second image, and determining, based on pixel locations of the plurality of points on the object in second image and the projected plurality of points on the object, a reprojection error.

### RELATED APPLICATIONS

This application claims the benefit under 35 U.S.C. § 119(e) of U.S. Provisional Patent Application Ser. No. 63/354,762, filed Jun. 23, 2022, and entitled, “ONLINE CAMERA CALIBRATION FOR A MOBILE ROBOT,” the entire contents of which is incorporated herein by reference.

### BACKGROUND

A robot is generally a reprogrammable and multifunctional manipulator, often designed to move material, parts, tools, or specialized devices through variable programmed motions for performance of tasks. Robots may be manipulators that are physically anchored (e.g., industrial robotic arms), mobile robots that move throughout an environment (e.g., using legs, wheels, or traction-based mechanisms), or some combination of a manipulator and a mobile robot. Robots are utilized in a variety of industries including, for example, manufacturing, warehouse logistics, transportation, hazardous environments, exploration, and healthcare.

### SUMMARY

In some embodiments, a method is provided. The method comprises receiving a first image captured by a first camera of a robot, wherein the first image includes an object having at least one known dimension, receiving a second image captured by a second camera of the robot, wherein the second image includes the object, wherein a field of view of the first camera and a field of view of the second camera at least partially overlap, projecting a plurality of points on the object in the first image to pixel locations in the second image, and determining, based on pixel locations of the plurality of points on the object in second image and the projected plurality of points on the object, a reprojection error.

In one aspect, the object includes a plurality of corner points, and wherein the plurality of points on the object projected to pixel locations in the second image includes at least two of the plurality of corner points. In one aspect, the object is a rectangle having four corner points, and wherein the plurality of points on the object projected to pixel locations in the second image includes the four corner points of the rectangle. In one aspect, the object is a fiducial marker in an environment of the robot. In one aspect, the fiducial marker is an AprilTag.

In one aspect, determining the reprojection error comprises calculating, for each of the plurality of points on the object, a first distance between the point on the object in the second image and the pixel location of the corresponding projected point in the second image, and determining the reprojection error based on the calculated first distances. In one aspect, determining the reprojection error based on the calculated distances comprises calculating a second distance of a longest edge of the object along two of the plurality of points on the object, dividing each of the calculated first distances by the second distance to generate normalized first distances, and determining the reprojection error as an average of the normalized first distances. In one aspect, the first camera is a vision camera and the second camera is a depth camera. In one aspect, the depth camera is a stereo vision camera.

In one aspect, the method further comprises generating an instruction to perform an action when the reprojection error is greater than a threshold value. In one aspect, generating an instruction to perform an action when the reprojection error is greater than a threshold value comprises generating an alert. In one aspect, generating an instruction to perform an action when the reprojection error is greater than a threshold value comprises generating an instruction to stop autonomous navigation of the robot. In one aspect, generating an instruction to perform an action comprises generating an instruction to calibrate one or more parameters associated with the first camera and/or the second camera based on the reprojection error. In one aspect, calibrating one or more parameters associated with the first camera and/or the second camera comprises updating a lens model for one or both of the first camera and/or the second camera. In one aspect, the robot is configured to use an extrinsics transform to relate a first coordinate system of the first camera to a second coordinate system of the second camera, and calibrating one or more parameters associated with the first camera and/or the second camera comprises updating the extrinsics transform. In one aspect, updating the extrinsics transform comprises capturing a set of first images from the first camera, wherein each of the first images in the set includes the object, capturing a set of second images from the second camera, wherein each of the second images in the set includes the object, each of the first images having a corresponding second image in the set of second image taken at a same time as the first image using a same pose, performing a non-linear optimization over the first set of images and the second set of images to minimize the reprojection error for pairs of images from the first set and the second set, wherein an output of the non-linear optimization is a current extrinsics transform, and updating the extrinsics transform used by the robot based on the current extrinsics transform output from the non-linear optimization. In one aspect, the method further comprises determining a pose of the robot using the updated extrinsics transform.

In some embodiments, a robot is provided. The robot comprises a perception system including a first camera configured to capture a first image, wherein the first image includes an object having at least one known dimension, and a second camera configured to capture a second image, wherein the second image includes the object, wherein a field of view of the first camera and a field of view of the second camera at least partially overlap. The robot further comprises at least one computer processor configured to project a plurality of points on the object in the first image to pixel locations in the second image, and determine, based on pixel locations of the plurality of points on the object in second image and the projected plurality of points on the object, a reprojection error.

In one aspect, the object includes a plurality of corner points, and wherein the plurality of points on the object projected to pixel locations in the second image includes at least two of the plurality of corner points. In one aspect, the object is a rectangle having four corner points, and wherein the plurality of points on the object projected to pixel locations in the second image includes the four corner points of the rectangle. In one aspect, the object is a fiducial marker in an environment of the robot. In one aspect, the fiducial marker is an AprilTag.

In one aspect, determining the reprojection error comprises calculating, for each of the plurality of points on the object, a first distance between the point on the object in the second image and the pixel location of the corresponding projected point in the second image, and determining the reprojection error based on the calculated first distances. In one aspect, determining the reprojection error based on the calculated distances comprises calculating a second distance of a longest edge of the object along two of the plurality of points on the object, dividing each of the calculated first distances by the second distance to generate normalized first distances, and determining the reprojection error as an average of the normalized first distances. In one aspect, the first camera is a vision camera and the second camera is a depth camera. In one aspect, the depth camera is a stereo vision camera.

In one aspect, the at least one computer processor is further configured to generate an instruction to perform an action when the reprojection error is greater than a threshold value. In one aspect, generating an instruction to perform an action when the reprojection error is greater than a threshold value comprises generating an alert. In one aspect, generating an instruction to perform an action when the reprojection error is greater than a threshold value comprises generating an instruction to stop autonomous navigation of the robot. In one aspect, generating an instruction to perform an action comprises generating an instruction to calibrate one or more parameters associated with the first camera and/or the second camera based on the reprojection error. In one aspect, calibrating one or more parameters associated with the first camera and/or the second camera comprises updating a lens model for one or both of the first camera and/or the second camera.

In one aspect, the robot is configured to use an extrinsics transform to relate a first coordinate system of the first camera to a second coordinate system of the second camera, and calibrating one or more parameters associated with the first camera and/or the second camera comprises updating the extrinsics transform. In one aspect, updating the extrinsics transform comprises capturing a set of first images from the first camera, wherein each of the first images in the set includes the object, capturing a set of second images from the second camera, wherein each of the second images in the set includes the object, each of the first images having a corresponding second image in the set of second image taken at a same time as the first image using a same pose, performing a non-linear optimization over the first set of images and the second set of images to minimize the reproj ection error for pairs of images from the first set and the second set, wherein an output of the non-linear optimization is a current extrinsics transform, and updating the extrinsics transform used by the robot based on the current extrinsics transform output from the non-linear optimization. In one aspect, the at least one computer processor is further configured to determine a pose of the robot using the updated extrinsics transform. In one aspect, the first camera and the second camera are mounted on a same substrate.

In some embodiments, a non-transitory computer readable medium is provided. The non-transitory computer readable medium is encoded with a plurality of instructions that, when executed by at least one computer processor perform a method. The method comprises receiving a first image captured by a first camera of a robot, wherein the first image includes an object having at least one known dimension, receiving a second image captured by a second camera of the robot, wherein the second image includes the object, wherein a field of view of the first camera and a field of view of the second camera at least partially overlap, projecting a plurality of points on the object in the first image to pixel locations in the second image, and determining, based on pixel locations of the plurality of points on the object in second image and the projected plurality of points on the object, a reprojection error.

In one aspect, the object includes a plurality of corner points, and wherein the plurality of points on the object projected to pixel locations in the second image includes at least two of the plurality of corner points. In one aspect, the object is a rectangle having four corner points, and wherein the plurality of points on the object projected to pixel locations in the second image includes the four corner points of the rectangle. In one aspect, the object is a fiducial marker in an environment of the robot. In one aspect, the fiducial marker is an AprilTag.

In one aspect, determining the reprojection error comprises calculating, for each of the plurality of points on the object, a first distance between the point on the object in the second image and the pixel location of the corresponding projected point in the second image, and determining the reprojection error based on the calculated first distances. In one aspect, determining the reprojection error based on the calculated distances comprises calculating a second distance of a longest edge of the object along two of the plurality of points on the object, dividing each of the calculated first distances by the second distance to generate normalized first distances, and determining the reprojection error as an average of the normalized first distances. In one aspect, the first camera is a vision camera and the second camera is a depth camera. In one aspect, the depth camera is a stereo vision camera.

In one aspect, the method further comprises generating an instruction to perform an action when the reprojection error is greater than a threshold value. In one aspect, generating an instruction to perform an action when the reprojection error is greater than a threshold value comprises generating an alert. In one aspect, generating an instruction to perform an action when the reprojection error is greater than a threshold value comprises generating an instruction to stop autonomous navigation of the robot. In one aspect, generating an instruction to perform an action comprises generating an instruction to calibrate one or more parameters associated with the first camera and/or the second camera based on the reprojection error. In one aspect, calibrating one or more parameters associated with the first camera and/or the second camera comprises updating a lens model for one or both of the first camera and/or the second camera.

In one aspect, the robot is configured to use an extrinsics transform to relate a first coordinate system of the first camera to a second coordinate system of the second camera, and calibrating one or more parameters associated with the first camera and/or the second camera comprises updating the extrinsics transform. In one aspect, updating the extrinsics transform comprises capturing a set of first images from the first camera, wherein each of the first images in the set includes the object, capturing a set of second images from the second camera, wherein each of the second images in the set includes the object, each of the first images having a corresponding second image in the set of second image taken at a same time as the first image using a same pose, performing a non-linear optimization over the first set of images and the second set of images to minimize the reproj ection error for pairs of images from the first set and the second set, wherein an output of the non-linear optimization is a current extrinsics transform, and updating the extrinsics transform used by the robot based on the current extrinsics transform output from the non-linear optimization. In one aspect, the method further comprises determining a pose of the robot using the updated extrinsics transform.

The foregoing apparatus and method embodiments may be implemented with any suitable combination of aspects, features, and acts described above or in further detail below. These and other aspects, embodiments, and features of the present teachings can be more fully understood from the following description in conjunction with the accompanying drawings.

### BRIEF DESCRIPTION OF DRAWINGS

Various aspects and embodiments will be described with reference to the following figures. It should be appreciated that the figures are not necessarily drawn to scale. In the drawings, each identical or nearly identical component that is illustrated in various figures is represented by a like numeral. For purposes of clarity, not every component may be labeled in every drawing.

FIG. 1A is a schematic view of an example robot for navigating through an environment;

FIG. 1B is a schematic view of a navigation system for navigating a robot such as the robot of FIG. 1A;

FIG. 2A is a schematic view of exemplary components of a navigation system such as the navigation system illustrated in FIG. 1B;

FIG. 2B is a schematic view of a topological map that may be used for navigating a robot such as the robot of FIG. 1A;

FIG. 3A schematically illustrates a first and second images captured by first and second cameras having at least partially overlapping fields of view, in accordance with some embodiments of the present disclosure;

FIG. 3B schematically illustrates a technique for projecting points on an object in a first image to pixel locations in a second image, in accordance with some embodiments of the present disclosure;

FIG. 4 is a flowchart of a process for performing an action based on a calibration error, in accordance with some embodiments of the present disclosure;

FIG. 5 is a flowchart of a process for performing online camera calibration, in accordance with some embodiments of the present disclosure; and

FIG. 6 is a block diagram of components of a robot on which some embodiments of the present disclosure may be implemented.

### DETAILED DESCRIPTION

Some robots are used to navigate environments to perform a variety of tasks or functions. These robots are often operated to perform a “mission” by navigating the robot through an environment. The mission is sometimes recorded so that the robot can again perform the mission at a later time. In some missions, a robot both navigates through and interacts with the environment. The interaction sometimes takes the form of gathering data using one or more sensors.

As discussed further herein, the one or more sensors associated with the robot may include multiple (e.g., at least two) cameras with at least partially overlapping fields of view, and the multiple cameras may be configured to capture images of the environment of the robot. The multiple cameras may include, for example, a visual camera configured to capture color (e.g., red-blue-green (RGB)) images of the environment and a depth camera (e.g., a stereo camera) configured to capture distance information from the camera to points in the environment. The images captured by the multiple cameras may be used to generate a three-dimensional representation of objects in the environment of the robot. The three-dimensional representation may be used to facilitate localization and/or navigation within the environment to, for instance, execute a mission. Occasionally (e.g., once a day, once a month), each of the multiple cameras may be calibrated using a calibration routine to ensure that the information included in the images captured from each of the cameras is spatially aligned to facilitate generation of an accurate three-dimensional representation of the robot's environment.

Due to a variety of factors (e.g., mechanical deformation of a substrate on which the cameras are mounted, thermal expansion/contraction, etc.) the calibration of the cameras relative to each other (e.g., a set of extrinsics parameters relating the cameras) may become degraded, such that points on an object captured in a first image by a first camera are represented at pixel locations in the first image that when projected (e.g., using the set of extrinsics parameters relating the cameras) to pixel locations of the object in a second image captured by a second camera are inconsistent, where the first and second images are captured at the same time. Introduction of such cross-camera calibration errors can result in performance issues for the robot such as, but not limited to, reduced localization accuracy, poor fiducial detection accuracy, and unreliable robot docking. Accordingly, some embodiments of the present disclosure relate to techniques for assessing a calibration error for multiple cameras with at least partially overlapping fields of view and performing an action when the calibration error exceeds a threshold. For instance, the action may be to perform online or “on-the-fly” calibration of the cameras, without requiring the robot to pause its normal activity and execute an explicit calibration routine.

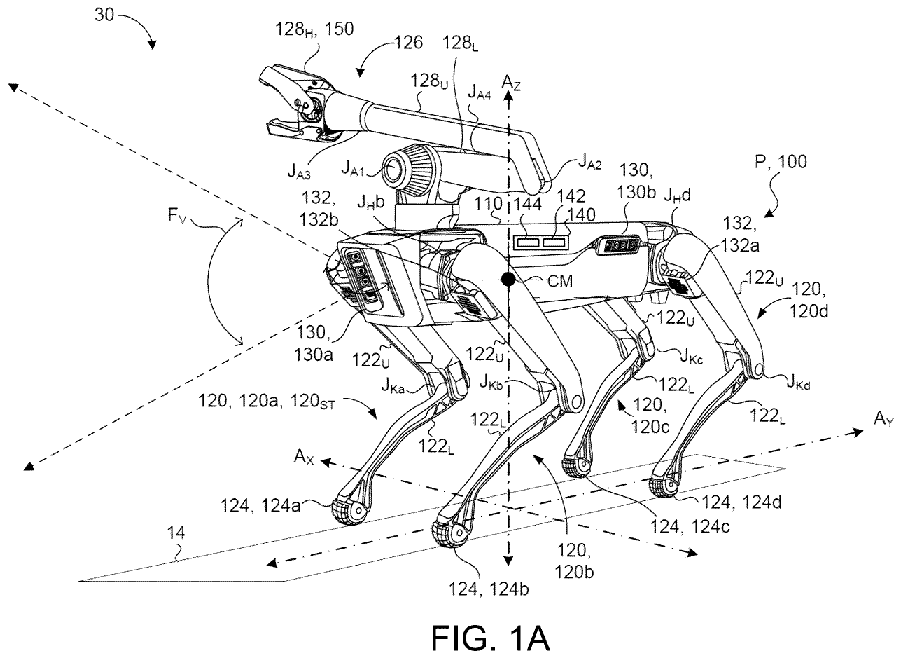

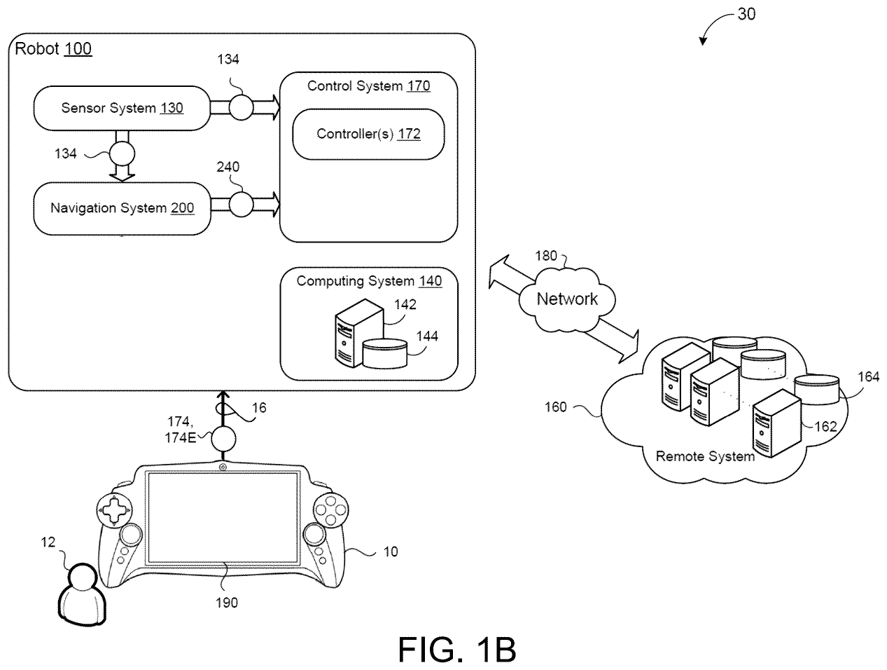

Referring to FIGS. 1A and 1B, in some implementations, a robot 100 includes a body 110 with locomotion based structures such as legs 120a-d coupled to the body 110 that enable the robot 100 to move through the environment 30. In some examples, each leg 120 is an articulable structure such that one or more joints J permit members 122 of the leg 120 to move. For instance, each leg 120 includes a hip joint J_{H} coupling an upper member 122, 122U of the leg 120 to the body 110 and a knee joint J_{K} coupling the upper member 122U of the leg 120 to a lower member 122L of the leg 120. Although FIG. 1A depicts a quadruped robot with four legs 120a-d, the robot 100 may include any number of legs or locomotive based structures (e.g., a biped or humanoid robot with two legs, or other arrangements of one or more legs) that provide a means to traverse the terrain within the environment 30.

In order to traverse the terrain, each leg 120 has a distal end 124 that contacts a surface of the terrain (i.e., a traction surface). In other words, the distal end 124 of the leg 120 is the end of the leg 120 used by the robot 100 to pivot, plant, or generally provide traction during movement of the robot 100. For example, the distal end 124 of a leg 120 corresponds to a foot of the robot 100. In some examples, though not shown, the distal end 124 of the leg 120 includes an ankle joint J_{A} such that the distal end 124 is articulable with respect to the lower member 122L of the leg 120.

In the examples shown, the robot 100 includes an arm 126 that functions as a robotic manipulator. The arm 126 may be configured to move about multiple degrees of freedom in order to engage elements of the environment 30 (e.g., objects within the environment 30). In some examples, the arm 126 includes one or more members 128, where the members 128 are coupled by joints J such that the arm 126 may pivot or rotate about the joint(s) J. For instance, with more than one member 128, the arm 126 may be configured to extend or to retract. To illustrate an example, FIG. 1A depicts the arm 126 with three members 128 corresponding to a lower member 128_{L}, an upper member 128_{U}, and a hand member 128_{H} (e.g., shown as an end-effector 150). Here, the lower member 128_{L} may rotate or pivot about a first arm joint J_{A1} located adjacent to the body 110 (e.g., where the arm 126 connects to the body 110 of the robot 100). The lower member 128_{L} is coupled to the upper member 128_{U} at a second arm joint J_{A2} and the upper member 128_{U} is coupled to the hand member 128_{H} at a third arm joint J_{A3}. In some examples, such as FIG. 1A, the hand member 128_{H} or end-effector 150 is a mechanical gripper that includes a moveable jaw and a fixed jaw configured to perform different types of grasping of elements within the environment 30. The moveable jaw is configured to move relative to the fixed jaw to move between an open position for the gripper and a closed position for the gripper. In some implementations, the arm 126 additionally includes a fourth joint J_{A4}. The fourth joint J_{A4} may be located near the coupling of the lower member 128_{L} to the upper member 128_{U} and function to allow the upper member 128_{U} to twist or rotate relative to the lower member 128_{L}. In other words, the fourth joint J_{A4} may function as a twist joint similarly to the third joint J_{A3} or wrist joint of the arm 126 adjacent the hand member 128_{H}. For instance, as a twist joint, one member coupled at the joint J may move or rotate relative to another member coupled at the joint J (e.g., a first member coupled at the twist joint is fixed while the second member coupled at the twist joint rotates). In some implementations, the arm 126 connects to the robot 100 at a socket on the body 110 of the robot 100. In some configurations, the socket is configured as a connector such that the arm 126 attaches or detaches from the robot 100 depending on whether the arm 126 is needed for operation.

The robot 100 has a vertical gravitational axis (e.g., shown as a Z-direction axis A_{Z}) along a direction of gravity, and a center of mass CM, which is a position that corresponds to an average position of all parts of the robot 100 where the parts are weighted according to their masses (i.e., a point where the weighted relative position of the distributed mass of the robot 100 sums to zero). The robot 100 further has a pose P based on the CM relative to the vertical gravitational axis A_{Z} (i.e., the fixed reference frame with respect to gravity) to define a particular attitude or stance assumed by the robot 100. The attitude of the robot 100 can be defined by an orientation or an angular position of the robot 100 in space. Movement by the legs 120 relative to the body 110 alters the pose P of the robot 100 (i.e., the combination of the position of the CM of the robot and the attitude or orientation of the robot 100). Here, a height generally refers to a distance along the z-direction. The sagittal plane of the robot 100 corresponds to the Y-Z plane extending in directions of a y-direction axis A_{Y} and the z-direction axis A_{Z}. In other words, the sagittal plane bisects the robot 100 into a left and a right side. Generally perpendicular to the sagittal plane, a ground plane (also referred to as a transverse plane) spans the X-Y plane by extending in directions of the x-direction axis A_{X} and the y direction axis A_{Y}. The ground plane refers to a ground surface 14 where distal ends 124 of the legs 120 of the robot 100 may generate traction to help the robot 100 move about the environment 30. Another anatomical plane of the robot 100 is the frontal plane that extends across the body 110 of the robot 100 (e.g., from a left side of the robot 100 with a first leg 120a to a right side of the robot 100 with a second leg 120b). The frontal plane spans the X-Z plane by extending in directions of the x-direction axis A_{X} and the z direction axis A_{Z}.

In order to maneuver about the environment 30 or to perform tasks using the arm 126, the robot 100 includes a sensor system 130 with one or more sensors 132, 132a-n (e.g., shown as a first sensor 132, 132a and a second sensor 132, 132b). The sensors 132 may include vision/image sensors, inertial sensors (e.g., an inertial measurement unit (IMU)), force sensors, and/or kinematic sensors. Some examples of sensors 132 include a camera such as a visual camera (e.g., an RGB camera), stereo camera, a scanning light-detection and ranging (LIDAR) sensor, or a scanning laser-detection and ranging (LADAR) sensor. In some examples, the sensor 132 has a corresponding field(s) of view F_{V} defining a sensing range or region corresponding to the sensor 132. For instance, FIG. 1A depicts a field of a view F_{V} for the robot 100. Each sensor 132 may be pivotable and/or rotatable such that the sensor 132, for example, changes its field of view F_{V} about one or more axis (e.g., an x-axis, a y-axis, or a z-axis in relation to a ground plane).

When surveying a field of view F_{V} with a sensor 132, the sensor system 130 generates sensor data 134 (also referred to herein as image data) corresponding to the field of view F_{V}. The sensor system 130 may generate the field of view F_{V} with a sensor 132 mounted on or near the body 110 of the robot 100 (e.g., sensor(s) 132a, 132b). The sensor system may additionally and/or alternatively generate the field of view F_{V} with a sensor 132 mounted at or near the end-effector 150 of the arm 126 (e.g., sensor(s) 132c). The one or more sensors 132 capture the sensor data 134 that defines a three-dimensional point cloud for the area within the environment 30 about the robot 100. In some examples, the sensor data 134 is image data that corresponds to a three-dimensional volumetric point cloud generated by a three-dimensional volumetric image sensor 132. In some embodiments, sensor system 130 includes multiple cameras having at least partially overlapping fields of view. For instance, sensor system 130 may include a visual camera (e.g., an RGB camera) configured to capture a 2D representation of the environment and a stereo camera configured to capture depth information. The visual camera and the stereo camera may have at least partially overlapping fields of view, and the images captured by the two cameras may be used to generate the three-dimensional point cloud. Because the two cameras are not precisely co-located, the sensor system 130 (or some other component of robot 100) may store a set of extrinsics parameters (e.g., an extrinsics transform) that relates a coordinate system of images captured by the first camera (e.g., the visual camera) and a coordinate system of images captured by the second camera (e.g., the stereo camera). The stored set of extrinsics parameters may be used, among other things, to generate the three-dimensional point cloud or determine the pose of the robot 100.

Additionally or alternatively, when the robot 100 is maneuvering about the environment 30, the sensor system 130 gathers pose data for the robot 100 that includes inertial measurement data (e.g., measured by an IMU). In some examples, the pose data includes kinematic data and/or orientation data about the robot 100, for instance, kinematic data and/or orientation data about joints J or other portions of a leg 120 or arm 126 of the robot 100. With the sensor data 134, various systems of the robot 100 may use the sensor data 134 to define a current state of the robot 100 (e.g., of the kinematics of the robot 100) and/or a current state of the environment 30 about the robot 100.

In some implementations, the sensor system 130 includes sensor(s) 132 coupled to a joint J. Moreover, these sensors 132 may couple to a motor M that operates a joint J of the robot 100 (e.g., sensors 132, 132a-b). Here, these sensors 132 generate joint dynamics in the form of joint-based sensor data 134. Joint dynamics collected as joint-based sensor data 134 may include joint angles (e.g., an upper member 122_{U} relative to a lower member 122_{L} or hand member 126_{H} relative to another member of the arm 126 or robot 100), joint speed, joint angular velocity, joint angular acceleration, and/or forces experienced at a joint J (also referred to as joint forces). Joint-based sensor data generated by one or more sensors 132 may be raw sensor data, data that is further processed to form different types of joint dynamics, or some combination of both. For instance, a sensor 132 measures joint position (or a position of member(s) 122 coupled at a joint J) and systems of the robot 100 perform further processing to derive velocity and/or acceleration from the positional data. In other examples, a sensor 132 is configured to measure velocity and/or acceleration directly.

As the sensor system 130 gathers sensor data 134, a computing system 140 stores, processes, and/or to communicates the sensor data 134 to various systems of the robot 100 (e.g., the control system 170, a navigation system 200, and/or remote controller 10). In order to perform computing tasks related to the sensor data 134, the computing system 140 of the robot 100 includes data processing hardware 142 and memory hardware 144. The data processing hardware 142 is configured to execute instructions stored in the memory hardware 144 to perform computing tasks related to activities (e.g., movement and/or movement based activities) for the robot 100. Generally speaking, the computing system 140 refers to one or more locations of data processing hardware 142 and/or memory hardware 144.

In some examples, the computing system 140 is a local system located on the robot 100. When located on the robot 100, the computing system 140 may be centralized (i.e., in a single location/area on the robot 100, for example, the body 110 of the robot 100), decentralized (i.e., located at various locations about the robot 100), or a hybrid combination of both (e.g., where a majority of centralized hardware and a minority of decentralized hardware). To illustrate some differences, a decentralized computing system 140 may allow processing to occur at an activity location (e.g., at motor that moves a joint of a leg 120), whereas a centralized computing system 140 may allow for a central processing hub that communicates to systems located at various positions on the robot 100 (e.g., communicate to the motor that moves the joint of the leg 120).

Additionally or alternatively, the computing system 140 includes computing resources that are located remote from the robot 100. For instance, the computing system 140 communicates via a network 180 with a remote system 160 (e.g., a remote server or a cloud-based environment). Much like the computing system 140, the remote system 160 includes remote computing resources such as remote data processing hardware 162 and remote memory hardware 164. Here, sensor data 134 or other processed data (e.g., data processing locally by the computing system 140) may be stored in the remote system 160 and may be accessible to the computing system 140. In additional examples, the computing system 140 is configured to utilize the remote resources 162, 164 as extensions of the computing resources 142, 144 such that resources of the computing system 140 reside on resources of the remote system 160.

In some implementations, as shown in FIGS. 1A and 1B, the robot 100 includes a control system 170. The control system 170 may be configured to communicate with systems of the robot 100, such as the at least one sensor system 130 and/or the navigation system 200. The control system 170 may perform operations and other functions using hardware 140. The control system 170 includes at least one controller 172 that is configured to control the robot 100. For example, the controller 172 controls movement of the robot 100 to traverse about the environment 30 based on input or feedback from the systems of the robot 100 (e.g., the sensor system 130 and/or the control system 170). In additional examples, the controller 172 controls movement between poses and/or behaviors of the robot 100. The at least one controller 172 may be responsible for controlling movement of the arm 126 of the robot 100 in order for the arm 126 to perform various tasks using the end-effector 150. For instance, at least one controller 172 controls the end-effector 150 (e.g., a gripper) to manipulate an object or element in the environment 30. For example, the controller 172 actuates the movable jaw in a direction towards the fixed jaw to close the gripper. In other examples, the controller 172 actuates the movable jaw in a direction away from the fixed jaw to close the gripper.

A given controller 172 may control the robot 100 by controlling movement about one or more joints J of the robot 100. In some configurations, the given controller 172 is implemented as software or firmware with programming logic that controls at least one joint J or a motor M which operates, or is coupled to, a joint J. A software application (i.e., a software resource) may refer to computer software that causes a computing device to perform a task. In some examples, a software application may be referred to as an “application,” an “app,” or a “program.” For instance, the controller 172 controls an amount of force that is applied to a joint J (e.g., torque at a joint J). As programmable controllers 172, the number of joints J that a controller 172 controls is scalable and/or customizable for a particular control purpose. A controller 172 may control a single joint J (e.g., control a torque at a single joint J), multiple joints J, or actuation of one or more members 128 (e.g., actuation of the hand member 128H) of the robot 100. By controlling one or more joints J, actuators or motors M, the controller 172 may coordinate movement for all different parts of the robot 100 (e.g., the body 110, one or more legs 120, the arm 126). For example, to perform some movements or tasks, a controller 172 may be configured to control movement of multiple parts of the robot 100 such as, for example, two legs 120a-b, four legs 120a-d, or two legs 120a-b combined with the arm 126.

With continued reference to FIG. 1B, an operator 12 (also referred to herein as a user or a client) may interact with the robot 100 via the remote controller 10 that communicates with the robot 100 to perform actions. For example, the operator 12 transmits commands 174 to the robot 100 (executed via the control system 170) via a wireless communication network 16. Additionally, the robot 100 may communicate with the remote controller 10 to display an image on a user interface 190 (e.g., UI 190) of the remote controller 10. For example, the UI 190 is configured to display the image that corresponds to three-dimensional field of view F_{V} of the one or more sensors 132. The image displayed on the UI 190 of the remote controller 10 is a two-dimensional image that corresponds to the three-dimensional point cloud of sensor data 134 for the area within the environment 30 about the robot 100. That is, the image displayed on the UI 190 may be a two-dimensional image representation that corresponds to the three-dimensional field of view F_{V} of the one or more sensors 132.

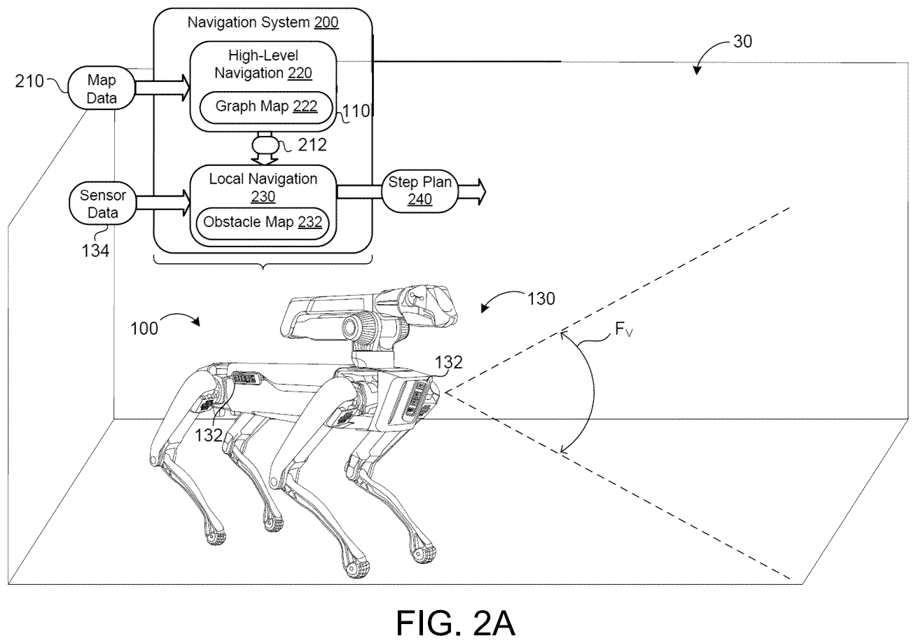

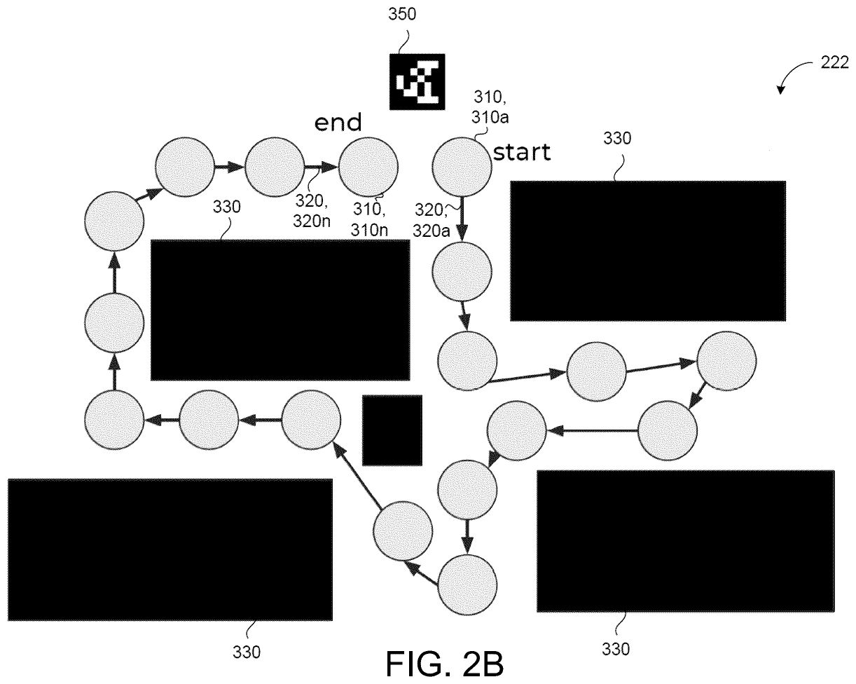

Referring now to FIG. 2A, the robot 100 (e.g., the data processing hardware 142) executes the navigation system 200 for enabling the robot 100 to navigate the environment 30. For example, the sensor system 130 includes one or more imaging sensors 132 (e.g., cameras) each of which captures image data or other sensor data 134 of the environment 30 surrounding the robot 100 within the field of view F_{V}. The sensor system 130 may be configured to move the field of view F_{V} of some or all of the sensors 130 by adjusting an angle of view or by panning and/or tilting (either independently or via the robot 100) one or more sensors 132 to move the field of view F_{V} of the sensor(s) 132 in any direction. In some implementations, the sensor system 130 includes multiple sensors or cameras 132 such that the sensor system 130 captures a generally 360-degree field of view around the robot 100. In some implementations, at least some of the sensors 130 in sensor system 130 have at least partially overlapping fields of view F_{V}.

In the example shown, the navigation system 200 includes a high-level navigation module 220 that receives map data 210 (e.g., high-level navigation data representative of locations of static obstacles in an area the robot 100 is to navigate). In some examples, the map data 210 includes a graph map 222. In other examples, the high-level navigation module 220 generates the graph map 222. The graph map 222 includes a topological map of a given area the robot 100 is to traverse. The high-level navigation module 220 obtains (e.g., from the remote system 160 or the remote controller 10) or generates a series of route waypoints 310 on the graph map 222 for a navigation route 212 that plots a path around large and/or static obstacles from a start location (e.g., the current location of the robot 100) to a destination as shown in FIG. 2B. Route edges 312 connect corresponding pairs of adjacent route waypoints 310. In some examples, the route edges 312 record geometric transforms between route waypoints 310 based on odometry data (i.e., data from motion sensors or image sensors to determine a change in the robot's position over time). The route waypoints 310 and the route edges 312 are representative of the navigation route 212 for the robot to follow from a start location to a destination location.

In some implementations, the high-level navigation module 220 produces the navigation route 212 over a greater than 10-meter scale (e.g., distances greater than 10 meters from the robot 100). The navigation system 200 also includes a local navigation module 230 that receives the navigation route 212 and the image or sensor data 134 from the sensor system 130. The local navigation module 230, using the sensor data 134, generates an obstacle map 232. The obstacle map 232 is a robot-centered map that maps obstacles (both static and dynamic) in the vicinity of the robot 100 based on the sensor data 134. For example, while the graph map 222 includes information relating to the locations of walls of a hallway, the obstacle map 232 (populated by the sensor data 134 as the robot 100 traverses the environment 30) may include information regarding a stack of boxes placed in the hallway that may not have been present during the original recording. The size of the obstacle map 232 may be dependent upon both the operational range of the sensors 132 and the available computational resources.

The local navigation module 230 generates a step plan 240 (e.g., using an A* search algorithm) that plots each individual step (or other movement) of the robot 100 to navigate from the current location of the robot 100 to the next route waypoint 310 along the navigation route 212. Using the step plan 240, the robot 100 maneuvers through the environment 30. The local navigation module 230 may find a path for the robot 100 to the next route waypoint 310 using an obstacle grid map based on the captured sensor data 134. In some examples, the local navigation module 230 operates on a range correlated with the operational range of the sensor 132 (e.g., four meters) that is generally less than the scale of high-level navigation module 220.

In some implementations, the graph map 222 includes information related to one or more fiducial markers 350. Each fiducial marker 350 may correspond to an object that is placed within the field of sensing of the robot 100, and the robot 100 may use the fiducial marker 350 as a fixed point of reference. Non-limiting examples of fiducial marker 350 include a bar code, a QR-code, an AprilTag, or other readily identifiable pattern or shape for the robot 100 to recognize. When placed in the environment of the robot, fiducial markers 350 may aid in navigation and/or localization through the environment.

During operation, a set of extrinsics parameters for one or more cameras included in the sensor module 130 of a robot can degrade, resulting in performance issues for the robot, such as reduced localization accuracy, poor fiducial detection accuracy, and unreliable robot docking. For instance, the camera(s) may be mounted on a substrate, such as a printed circuit board (PCB), and the substrate may bend or otherwise mechanically deform due to changes in temperature or other factors. Additionally, due to mechanical deformation and/or thermal expansion/contraction, the projection of incident light provided from the lens of a camera to the image sensor may change, resulting in a miscalibration of the camera.

Recalibration of the set of extrinsics parameters for a camera mounted on a robot is performed in some existing systems by removing the camera from the robot, placing the camera in a calibration test apparatus, and executing an explicit calibration routine using a particular calibration target. Use of such a manual calibration technique can be undesirable as it can result in downtime for the robot. Some embodiments of the present disclosure relate to techniques for detecting when a current set of extrinsics parameters being used by a robot has degraded sufficiently such that recalibration of the set of extrinsics parameters is needed. Upon determining that recalibration is needed, some embodiments then perform an action, such as generating an alert or performing online camera calibration using one or more of the techniques described herein.

Rather that requiring a robot to perform an explicit calibration routine using a particular calibration target, some embodiments of the present disclosure assess degradation of a current set of extrinsics parameters used by a robot, at least in part, using image data captured during normal operation of the robot, resulting in little or no downtime for the robot. For instance, one or more cameras of a robot may be configured to capture images that include an object (e.g., fiducial marker 350) having at least one known dimension (e.g., a sign having one or more known dimensions), wherein the object is located in the environment through which a robot travels. As described herein fiducial markers 350 may be captured in images during routine operation of the robot for localization and/or navigation purposes. Some implementations of the techniques described herein repurpose this information already being collected by the robot to assess, and in some instances, automatically correct miscalibration of a camera.

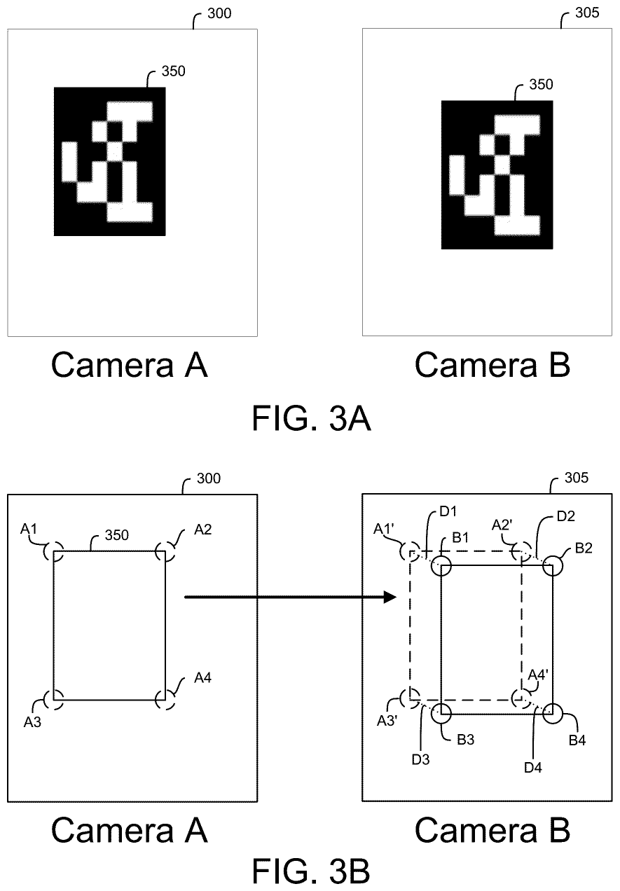

FIG. 3A illustrates a first image 300 captured by a first camera (Camera A) of a robot and a second image 305 captured by a second camera (Camera B) of the robot. Each of the first image 300 and the second image 305 includes the same fiducial marker 350, located at slightly different positions in the image. In this example, Camera A may be a visual camera (e.g., an RGB camera) and Camera B may be a stereo camera, such that the images captured by Camera A and Camera B may be used to generate a three-dimensional point cloud of objects in the environment. It should be appreciated however, that any camera configured to capture images of the environment of the robot may be used in accordance with the calibration techniques described herein. Camera A and Camera B are arranged to have at least partially overlapping fields of view, such that the first image 300 and the second image 305, when captured at the same time (or substantially the same time), both include fiducial marker 350. Due to the partially overlapping fields of view of the two cameras, the location of the fiducial marker 350 in the first image 300 and the second image 305 when projected from one image to the other (e.g., projected from the first image 300 to the second image 305) should be the same when the current set of extrinsics parameters relating the two cameras and used for the projection is accurate (e.g., has not been degraded). However, as shown schematically in FIG. 3A, when the current set of extrinsics parameters relating camera A and camera B is degraded, the location of the fiducial marker 350 within the images is different. Some embodiments of the present disclosure relate to a process for detecting an amount of calibration error for a camera based on the extent to which there is a position offset of an object having at least one known dimension (e.g., a fiducial marker 350) in two images simultaneously (or near simultaneously) captured by cameras having at least partial overlapping fields of view.

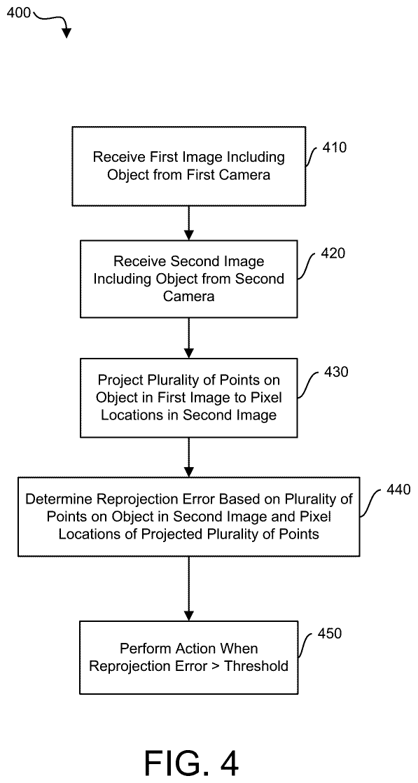

FIG. 4 illustrates a process 400 for determining a calibration error of a first camera relative to a second camera of a mobile robot, in accordance with some embodiments. In act 410, a first image captured by a first camera of a robot is received. The first image includes an object, such as a fiducial marker, that has at least one known dimension. Process 400 then proceeds to act 420, where a second image captured by a second camera of the robot is received. The second camera has at least a partially overlapping field of view as the first camera such that the second image also includes the object included in the first image. In some implementations, the first camera and the second camera may be mounted on a common substrate (e.g., a printed circuit board) incorporated into a sensor module of the robot (e.g., sensor module 130 of robot 100 described in FIG. 1A). Although shown as sequential acts in process 400, it should be appreciated that act 410 and act 420 may be performed simultaneously or near simultaneously (e.g., within several milliseconds) in any order. For instance, in some implementations, when a fiducial marker is detected in the first image captured by the first camera, a controller configured to control operation of the second camera may instruct the second camera to capture the second image at substantially the same time.

After receiving the first image and the second image, process 400 proceeds to act 430, where a plurality of points on the object (e.g., the fiducial marker) in the first image are projected from the first image to the second image. Any suitable number of points (e.g., two or more points) on the object may be projected from the first image to the second image. A current set of extrinsics parameters (e.g., in persistent storage of the robot) relating a coordinate system of images captured by Camera A and a coordinate system of images captured by Camera B may be used to project the plurality of point on the object from the first image to the second image.

FIG. 3B schematically illustrates a process for projecting a plurality of points on an object captured in a first image to a second image. The fiducial marker 350 included in the first image captured by camera A includes four corner points A1, A2, A3, A4. Each of the four corner points is projected to corresponding pixel locations A1′, A2′, A3′, A4′ in the second image (labeled Camera B in FIG. 3B) using, for example, a current set of extrinsics parameters. Although shown as being projected in two dimensions, it should be appreciated that in some embodiments, the projection of the plurality of points may occur in three dimensions. It should also be appreciated that the object from which the plurality of points is projected may have any suitable shape, provided that at least one dimension of the object is known. In some existing techniques for performing automatic calibration of a camera, the calibration is performed using natural features of the environment. The inventors have recognized that variations in textures and other features of the environment, when not taken into account by the calibration technique, may result in poor calibration of camera extrinsic parameters. To this end, the techniques described herein for assessing a calibration error of a camera rely on detection of objects, such as fiducial markers with at least one known or standardized dimension, to reduce or eliminate the effect of such variations in the environment.

Following projection of the plurality of points on an object included in a first image to pixel locations (or voxel locations in a three-dimensional projection) in a second image, process 400 proceeds to act 440, where a calibration error (also referred herein as a “reprojection error”) is determined based on the plurality of points on the object in the second image and the pixel locations of the projected plurality of points on the object from the first image. The “Camera B” representation shown in FIG. 3B shows the pixel locations of the four corners of the object labeled as B1, B2, B3, and B4 in the second image and the pixel locations A1′, A2′, A3′, A4′ corresponding to the projected points of the same four corners of the object from the first image. In some implementations the points on the object B1, B2, B3, B4 may be identified within a region of interest (ROI) defined based on the pixel locations A1′, A2′, A3′, A4′ corresponding to the projected points of the same four corners of the object from the first image. That is, rather than having to search the entire second image for the object, which may be computationally expensive, some implementations project the points A1, A2, A3, A4 from the first image to the second image and, based on the pixel locations A1′, A2′, A3′, A4′ of the projected points define an ROI within the second image to search for the object (e.g., a slightly larger region of the second image within which pixel locations A1′, A2′, A3′, A4′ fall. By searching a smaller region of the second image for the object, the process of identifying the object in the second image and its corresponding points B1, B2, B3, B4 is quicker and uses less computational resources than if the entire second image was searched.

In some embodiments, the reprojection error is determined based, at least in part, on a distance between the pixel locations of the projected points A1′, A2′, A3′, A4′ and the corresponding points B1, B2, B3, B4 in the second image. In the example of FIG. 3B, the corresponding distances are labeled D1, D2, D3, D4 for the pairs of object points and projected object points. In some implementations, the reprojection error may be determined as an average of the distances for each of the points on the object (e.g., an average of distances D1, D2, D3, D4). In some implementations, the distances for each of the points on the object may be normalized to at least partially account for differences in the incident angle of the cameras relative to the object. For instance, in some implementations a longest side of the object may be determined, and each of the distances (e.g., D1, D2, D3, D4) may be divided by the length of the longest side to generate normalized distances. The reprojection error may then be determined as an average of the normalized distances. Although the distances D1, D2, D3, D4 are shown as distances calculated in two dimensions, it should be appreciated that when the object points from the first image are projected in three dimensions, the distances may be calculated in three dimensions.

After determining the reprojection error, process 400 proceeds to act 450, where an action is performed when the reprojection error is greater than a threshold value. The threshold value may be set in any suitable way. For instance, the threshold value may be set based on one or more dimensions of the object (e.g., a fiducial marker) in the first and second images. When the reprojection error exceeds the threshold value, it is an indication that recalibration of the current set of extrinsics parameters should be performed. The action performed in act 450 may depend on the particular implementation. For instance, in some implementations, the action may be to output an alert to an operator of the robot (e.g., via remote controller 10 or an indicator on the robot) to instruct the operator that the cameras should be recalibrated. In some implementations, the robot may be configured to perform autonomous navigation through an environment using the techniques described herein. In such implementations, the action performed in act 450 may be to control the robot to stop autonomous navigation until the cameras can be recalibrated. Stopping autonomous navigation of the robot while the cameras are determined to be miscalibrated by a certain amount may help facilitate accurate navigation of the robot through the environment.

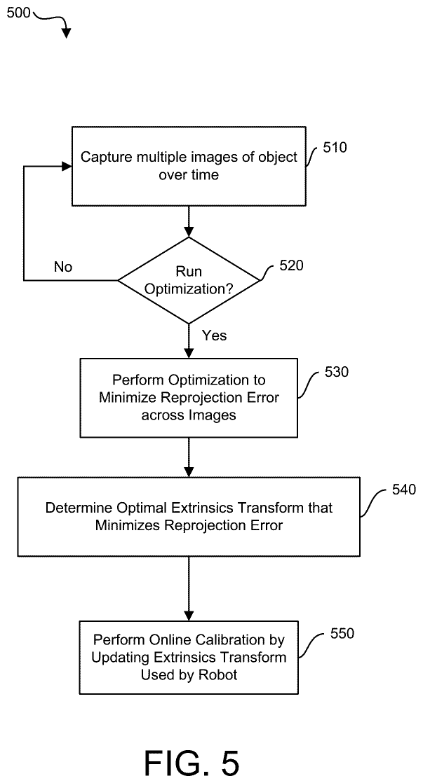

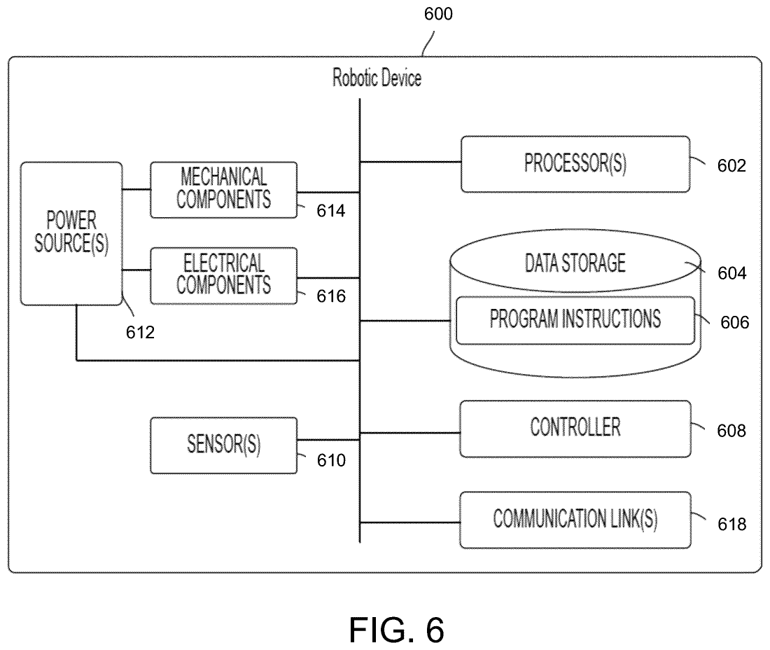

In some implementations, the action performed in act 450 may include performing an online camera calibration. An example of performing an online camera calibration in accordance with some embodiments is described in more detail with regard to FIG. 5. In some implementations, the action performed in act 450 includes performing multiple actions. For instance, an alert may be output to the operator of the robot and online camera calibration may be performed using one or more of the techniques described herein.

FIG. 5 illustrates a process 500 for performing an online camera calibration in accordance with some embodiments. In act 510, multiple images of an object (e.g., a fiducial marker) having at least one known dimension is captured by at least two cameras of a sensor module of a robot. For instance, a first set of first images captured by a first camera and a second set of second images captured simultaneously or near simultaneously by a second camera may be stored, with each of the images in the first set and the second set including the object. In some implementations, camera systems on the robot may be configured to capture images of the environment at a predetermined frequency (e.g., 1 Hz, 2 Hz, 5 Hz) during its normal operation while navigating through an environment. Some of the captured images may include the object (e.g., a fiducial marker) located in the environment. When a fiducial marker is detected in a first image from a first camera, a second camera with at least partial overlapping field of view with the first camera may be controlled to capture a second image also including the same object. The first image and the second image may form a pair of images used to perform online camera calibration, with the first image being included in the first set and the second image being included in the second set. Additional first and second images may be captured and included in the first set and the second set, for example, as the robot navigates through the environment and encounters more instances of the object (e.g., a fiducial marker).

Process 500 then proceeds to act 520, where it is determined whether to perform an optimization based on the captured data in the first set and the second set. The determination of whether to optimize may be made in any suitable way. For instance, in some implementations, a threshold amount of images in the first set and the second set may be required prior to performing optimization. In some implementations, a particular variation and/or distribution of locations and/or angles of the object in the captured images may be required prior to performing optimization. Any other suitable metrics may additionally or alternatively be used to determine whether the captured images in the first set and the second set provide sufficient data to perform optimization. If it is determined in act 520 that optimization is not to be performed, process 500 returns to act 510, where additional images including the object are captured until it is determined in act 520 that the images in the first set and the second set are sufficient to perform an optimization.

As described herein, in processing images captured by a first camera (e.g., a visual camera) and second camera (e.g., a depth camera) to generate a three-dimensional representation of objects in an environment, a set of extrinsics parameters (also referred to herein as an “extrinsics transform”) may be stored by a storage device (e.g., in a configuration file) of the robot to relate the coordinate systems of images captured by the first camera and the second camera. The stored extrinsics transform may be used by various systems of the robot to compute, among other things, the pose of the robot. When cameras are “misconfigured,” the extrinsics transform used by the robot to align the coordinate systems of the images captured by the cameras may not provide a sufficiently accurate result (e.g., the pose determined using the extrinsics transform may not be sufficiently accurate). By updating the stored extrinsics transform used by the robot using one or more optimization techniques as described herein, the cameras can be considered “recalibrated” such that the updated extrinsics transform, when used by the robot generates a more accurate result than if the extrinsics transform was not updated.

When it is determined in act 520 that optimization is to be performed, process 500 proceeds to act 530, where the images in the first and second set are provided as input to an optimization routine. Non-limiting examples of optimization routines that may be used in accordance with some embodiments include nonlinear least squares techniques (e.g., Levenberg-Marquardt optimization) and sparse optimization techniques. As described above, the optimization routine may be configured to output an updated extrinsics transform that relates the coordinate systems of the first and second cameras, and may be used, for example, to determine the pose of the robot. To determine the updated extrinsics transform, the optimization routine may be configured to minimize a reprojection error calculated when points on an object are projected from a first image in the first set to pixel locations in the corresponding second image in the second set. Process 500 then proceeds to act 540, where an optimal extrinsics transform that minimizes the reprojection error is output from the optimization routine. Including a variety of images in the first set and second set in which the object is viewed from different angles and positions within the images may help ensure that the optimal extrinsics transform output from the optimization routine generalizes over a broad range of image capture scenarios.

Process 500 then proceeds to act 550, where online camera calibration is performed by updating the current set of extrinsics parameters used by the robot to, for example, determine a pose of the robot. Updating the current set of extrinsics parameters may be performed in some instances by updating a configuration file that stores the current set of extrinsics parameters for use by one or more systems of the robot.

It should be appreciated that in some embodiments, the optimization routine may be configured to additionally or alternatively output a different metric other than an optimal extrinsics transform. For instance, the optimization routine may additionally or alternatively be configured to output one or more parameters (e.g., a focal length, a principal point, one or more distortion coefficients) for an optimal lens model (e.g., a pinhole camera model) for one or both of the first and second cameras.

In some implementations, the online camera calibration processes described herein are performed “in the background” such that the operator of the robot is not made aware that the calibration is being periodically assessed and updated automatically. In some implementations, each time online recalibration is performed, information regarding the recalibration may be stored on a storage device (e.g., in a log file) of the robot to save a record of aspects of the recalibration.

FIG. 6 illustrates an example configuration of a robotic device (or “robot”) 600, according to some embodiments. The robotic device 600 may, for example, correspond to the robot 100 described above. The robotic device 600 represents an illustrative robotic device configured to perform any of the techniques described herein. The robotic device 600 may be configured to operate autonomously, semi-autonomously, and/or using directions provided by user(s), and may exist in various forms, such as a humanoid robot, biped, quadruped, or other mobile robot, among other examples. Furthermore, the robotic device 600 may also be referred to as a robotic system, mobile robot, or robot, among other designations.

As shown in FIG. 6, the robotic device 600 may include processor(s) 602, data storage 604, program instructions 606, controller 608, sensor(s) 610, power source(s) 612, mechanical components 614, and electrical components 616. The robotic device 600 is shown for illustration purposes and may include more or fewer components without departing from the scope of the disclosure herein. The various components of robotic device 600 may be connected in any manner, including via electronic communication means, e.g., wired or wireless connections. Further, in some examples, components of the robotic device 1000 may be positioned on multiple distinct physical entities rather on a single physical entity.

The processor(s) 602 may operate as one or more general-purpose processor or special purpose processors (e.g., digital signal processors, application specific integrated circuits, etc.). The processor(s) 602 may, for example, correspond to the data processing hardware 142 of the robot 100 described above. The processor(s) 602 can be configured to execute computer-readable program instructions 606 that are stored in the data storage 604 and are executable to provide the operations of the robotic device 600 described herein. For instance, the program instructions 606 may be executable to provide operations of controller 608, where the controller 608 may be configured to cause activation and/or deactivation of the mechanical components 614 and the electrical components 616. The processor(s) 602 may operate and enable the robotic device 600 to perform various functions, including the functions described herein.

The data storage 604 may exist as various types of storage media, such as a memory. The data storage 604 may, for example, correspond to the memory hardware 144 of the robot 100 described above. The data storage 604 may include or take the form of one or more non-transitory computer-readable storage media that can be read or accessed by processor(s) 602. The one or more computer-readable storage media can include volatile and/or non-volatile storage components, such as optical, magnetic, organic or other memory or disc storage, which can be integrated in whole or in part with processor(s) 602. In some implementations, the data storage 604 can be implemented using a single physical device (e.g., one optical, magnetic, organic or other memory or disc storage unit), while in other implementations, the data storage 604 can be implemented using two or more physical devices, which may communicate electronically (e.g., via wired or wireless communication). Further, in addition to the computer-readable program instructions 606, the data storage 1004 may include additional data such as diagnostic data, among other possibilities.

The robotic device 600 may include at least one controller 608, which may interface with the robotic device 600 and may be either integral with the robotic device, or separate from the robotic device 600. The controller 608 may serve as a link between portions of the robotic device 600, such as a link between mechanical components 614 and/or electrical components 616. In some instances, the controller 608 may serve as an interface between the robotic device 600 and another computing device. Furthermore, the controller 608 may serve as an interface between the robotic system 600 and a user(s). The controller 608 may include various components for communicating with the robotic device 600, including one or more joysticks or buttons, among other features. The controller 608 may perform other operations for the robotic device 600 as well. Other examples of controllers may exist as well.

Additionally, the robotic device 600 may include one or more sensor(s) 610 such as image sensors, force sensors, proximity sensors, motion sensors, load sensors, position sensors, touch sensors, depth sensors, ultrasonic range sensors, and/or infrared sensors, or combinations thereof, among other possibilities. The sensor(s) 610 may, for example, correspond to the sensors 132 of the robot 100 described above. The sensor(s) 610 may provide sensor data to the processor(s) 602 to allow for appropriate interaction of the robotic system 600 with the environment as well as monitoring of operation of the systems of the robotic device 600. The sensor data may be used in evaluation of various factors for activation and deactivation of mechanical components 614 and electrical components 616 by controller 608 and/or a computing system of the robotic device 600.

The sensor(s) 610 may provide information indicative of the environment of the robotic device for the controller 608 and/or computing system to use to determine operations for the robotic device 600. For example, the sensor(s) 610 may capture data corresponding to the terrain of the environment or location of nearby objects, which may assist with environment recognition and navigation, etc. In an example configuration, the robotic device 600 may include a sensor system that may include a camera, RADAR, LIDAR, time-of-flight camera, global positioning system (GPS) transceiver, and/or other sensors for capturing information of the environment of the robotic device 600. The sensor(s) 610 may monitor the environment in real-time and detect obstacles, elements of the terrain, weather conditions, temperature, and/or other parameters of the environment for the robotic device 600.

Further, the robotic device 600 may include other sensor(s) 610 configured to receive information indicative of the state of the robotic device 600, including sensor(s) 610 that may monitor the state of the various components of the robotic device 600. The sensor(s) 610 may measure activity of systems of the robotic device 600 and receive information based on the operation of the various features of the robotic device 600, such as the operation of extendable legs, arms, or other mechanical and/or electrical features of the robotic device 600. The sensor data provided by the sensors may enable the computing system of the robotic device 600 to determine errors in operation as well as monitor overall functioning of components of the robotic device 600.

For example, the computing system may use sensor data to determine the stability of the robotic device 600 during operations as well as measurements related to power levels, communication activities, components that require repair, among other information. As an example configuration, the robotic device 600 may include gyroscope(s), accelerometer(s), and/or other possible sensors to provide sensor data relating to the state of operation of the robotic device. Further, sensor(s) 610 may also monitor the current state of a function, such as a gait, that the robotic system 600 may currently be operating. Additionally, the sensor(s) 610 may measure a distance between a given robotic leg of a robotic device and a center of mass of the robotic device. Other example uses for the sensor(s) 610 may exist as well.

Additionally, the robotic device 600 may also include one or more power source(s) 612 configured to supply power to various components of the robotic device 600. Among possible power systems, the robotic device 600 may include a hydraulic system, electrical system, batteries, and/or other types of power systems. As an example illustration, the robotic device 600 may include one or more batteries configured to provide power to components via a wired and/or wireless connection. Within examples, components of the mechanical components 614 and electrical components 616 may each connect to a different power source or may be powered by the same power source. Components of the robotic system 600 may connect to multiple power sources as well.

Within example configurations, any suitable type of power source may be used to power the robotic device 600, such as a gasoline and/or electric engine. Further, the power source(s) 612 may charge using various types of charging, such as wired connections to an outside power source, wireless charging, combustion, or other examples. Other configurations may also be possible. Additionally, the robotic device 600 may include a hydraulic system configured to provide power to the mechanical components 614 using fluid power. Components of the robotic device 600 may operate based on hydraulic fluid being transmitted throughout the hydraulic system to various hydraulic motors and hydraulic cylinders, for example. The hydraulic system of the robotic device 600 may transfer a large amount of power through small tubes, flexible hoses, or other links between components of the robotic device 600. Other power sources may be included within the robotic device 600.

Mechanical components 614 can represent hardware of the robotic system 600 that may enable the robotic device 600 to operate and perform physical functions. As a few examples, the robotic device 600 may include actuator(s), extendable leg(s) (“legs”), arm(s), wheel(s), one or multiple structured bodies for housing the computing system or other components, and/or other mechanical components. The mechanical components 614 may depend on the design of the robotic device 600 and may also be based on the functions and/or tasks the robotic device 600 may be configured to perform. As such, depending on the operation and functions of the robotic device 600, different mechanical components 614 may be available for the robotic device 600 to utilize. In some examples, the robotic device 600 may be configured to add and/or remove mechanical components 614, which may involve assistance from a user and/or other robotic device. For example, the robotic device 600 may be initially configured with four legs, but may be altered by a user or the robotic device 600 to remove two of the four legs to operate as a biped. Other examples of mechanical components 614 may be included.

The electrical components 616 may include various components capable of processing, transferring, providing electrical charge or electric signals, for example. Among possible examples, the electrical components 616 may include electrical wires, circuitry, and/or wireless communication transmitters and receivers to enable operations of the robotic device 600. The electrical components 616 may interwork with the mechanical components 614 to enable the robotic device 600 to perform various operations. The electrical components 616 may be configured to provide power from the power source(s) 612 to the various mechanical components 614, for example. Further, the robotic device 600 may include electric motors. Other examples of electrical components 616 may exist as well.

In some implementations, the robotic device 600 may also include communication link(s) 618 configured to send and/or receive information. The communication link(s) 618 may transmit data indicating the state of the various components of the robotic device 600. For example, information read in by sensor(s) 610 may be transmitted via the communication link(s) 618 to a separate device. Other diagnostic information indicating the integrity or health of the power source(s) 612, mechanical components 614, electrical components 618, processor(s) 602, data storage 604, and/or controller 608 may be transmitted via the communication link(s) 618 to an external communication device.

In some implementations, the robotic device 600 may receive information at the communication link(s) 618 that is processed by the processor(s) 602. The received information may indicate data that is accessible by the processor(s) 602 during execution of the program instructions 606, for example. Further, the received information may change aspects of the controller 608 that may affect the behavior of the mechanical components 614 or the electrical components 616. In some cases, the received information indicates a query requesting a particular piece of information (e.g., the operational state of one or more of the components of the robotic device 600), and the processor(s) 602 may subsequently transmit that particular piece of information back out the communication link(s) 618.

In some cases, the communication link(s) 618 include a wired connection. The robotic device 600 may include one or more ports to interface the communication link(s) 618 to an external device. The communication link(s) 618 may include, in addition to or alternatively to the wired connection, a wireless connection. Some example wireless connections may utilize a cellular connection, such as CDMA, EVDO, GSM/GPRS, or 4G telecommunication, such as WiMAX or LTE. Alternatively or in addition, the wireless connection may utilize a Wi-Fi connection to transmit data to a wireless local area network (WLAN). In some implementations, the wireless connection may also communicate over an infrared link, radio, Bluetooth, or a near-field communication (NFC) device.

The above-described embodiments can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-described functions. The one or more controllers can be implemented in numerous ways, such as with dedicated hardware or with one or more processors programmed using microcode or software to perform the functions recited above.

Various aspects of the present technology may be used alone, in combination, or in a variety of arrangements not specifically described in the embodiments described in the foregoing and are therefore not limited in their application to the details and arrangement of components set forth in the foregoing description or illustrated in the drawings. For example, aspects described in one embodiment may be combined in any manner with aspects described in other embodiments.

Also, some embodiments may be implemented as one or more methods, of which an example has been provided. The acts performed as part of the method(s) may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing,” “involving,” and variations thereof, is meant to encompass the items listed thereafter and additional items.

Having described several embodiments in detail, various modifications and improvements will readily occur to those skilled in the art. Such modifications and improvements are intended to be within the spirit and scope of the technology. Accordingly, the foregoing description is by way of example only, and is not intended as limiting.

What is claimed is:

1. A method, comprising:
receiving a first image captured by a first camera of a robot, wherein the first image includes an object having at least one known dimension;
receiving a second image captured by a second camera of the robot, wherein the second image includes the object, wherein a field of view of the first camera and a field of view of the second camera at least partially overlap;
projecting a plurality of points on the object in the first image to pixel locations in the second image; and
determining, based on pixel locations of the plurality of points on the object in second image and the projected plurality of points on the object, a reprojection error.

2. The method of claim 1, wherein the object includes a plurality of corner points, and wherein the plurality of points on the object projected to pixel locations in the second image includes at least two of the plurality of corner points.

3. The method of claim 2, wherein the object is a rectangle having four corner points, and wherein the plurality of points on the object projected to pixel locations in the second image includes the four corner points of the rectangle.

4. The method of claim 1, wherein the object is a fiducial marker in an environment of the robot.

5. The method of claim 4, wherein the fiducial marker is an AprilTag.

6. The method of claim 1, wherein determining the reprojection error comprises:
calculating, for each of the plurality of points on the object, a first distance between the point on the object in the second image and the pixel location of the corresponding projected point in the second image; and
determining the reprojection error based on the calculated first distances.

7. The method of claim 6, wherein determining the reprojection error based on the calculated distances comprises:
calculating a second distance of a longest edge of the object along two of the plurality of points on the object;
dividing each of the calculated first distances by the second distance to generate normalized first distances; and
determining the reprojection error as an average of the normalized first distances.

8. The method of claim 1, wherein the first camera is a vision camera and the second camera is a depth camera.

9. The method of claim 8, wherein the depth camera is a stereo vision camera.

10. The method of claim 1, further comprising:
generating an instruction to perform an action when the reprojection error is greater than a threshold value.

11. The method of claim 10, wherein generating an instruction to perform an action when the reprojection error is greater than a threshold value comprises generating an alert.

12. The method of claim 10, wherein generating an instruction to perform an action when the reprojection error is greater than a threshold value comprises generating an instruction to stop autonomous navigation of the robot.

13. The method of claim 10, wherein generating an instruction to perform an action comprises generating an instruction to calibrate one or more parameters associated with the first camera and/or the second camera based on the reprojection error.

14. The method of claim 13, wherein calibrating one or more parameters associated with the first camera and/or the second camera comprises updating a lens model for the first camera and/or the second camera.

15. The method of claim 13, wherein
the robot is configured to use an extrinsics transform to relate a first coordinate system of the first camera to a second coordinate system of the second camera, and
calibrating one or more parameters associated with the first camera and/or the second camera comprises updating the extrinsics transform.

16. The method of claim 15, wherein updating the extrinsics transform comprises:
capturing a set of first images from the first camera, wherein each of the first images in the set includes the object;
capturing a set of second images from the second camera, wherein each of the second images in the set includes the object, each of the first images having a corresponding second image in the set of second image taken at a same time as the first image using a same pose;
performing a non-linear optimization over the first set of images and the second set of images to minimize the reprojection error for pairs of images from the first set and the second set, wherein an output of the non-linear optimization is a current extrinsics transform; and
updating the extrinsics transform used by the robot based on the current extrinsics transform output from the non-linear optimization.

17. The method of claim 15, further comprising:
determining a pose of the robot using the updated extrinsics transform.

18. A robot, comprising:
a perception system including:
a first camera configured to capture a first image, wherein the first image includes an object having at least one known dimension; and
a second camera configured to capture a second image, wherein the second image includes the object, wherein a field of view of the first camera and a field of view of the second camera at least partially overlap; and
at least one computer processor configured to:
project a plurality of points on the object in the first image to pixel locations in the second image; and
determine, based on pixel locations of the plurality of points on the object in second image and the projected plurality of points on the object, a reprojection error.

19. The robot of claim 18, wherein the object includes a plurality of corner points, and wherein the plurality of points on the object projected to pixel locations in the second image includes at least two of the plurality of corner points.

20-35. (canceled)

36. A non-transitory computer readable medium encoded with a plurality of instructions that, when executed by at least one computer processor perform a method, the method comprising:
receiving a first image captured by a first camera of a robot, wherein the first image includes an object having at least one known dimension;
receiving a second image captured by a second camera of the robot, wherein the second image includes the object, wherein a field of view of the first camera and a field of view of the second camera at least partially overlap;
projecting a plurality of points on the object in the first image to pixel locations in the second image; and
determining, based on pixel locations of the plurality of points on the object in second image and the projected plurality of points on the object, a reprojection error.

37-52. (canceled)
